(19) United States
(12) Patent Application Publication
(10) Pub. No.: US 2015/0068408 A1
(43) Pub. Date: Mar. 12, 2015

(54) COOKER

(71) Applicant: Panasonic Corporation, Kadoma-shi, Osaka (JP)

(72) Inventors: Erina Nagae, Kumamoto (JP); Kohji Niiyama, Hyogo (JP)

(21) Appl. No.: 14/389,044

(22) PCT Filed: Nov. 28, 2013
(86) PCT No.: PCT/JP2013/007002

§ 371 Date: Sep. 29, 2014

(30) Foreign Application Priority Data
Dec. 20, 2012 (JP) 2012-277779

(51) Int. Cl. H05B 6/12

(52) U.S. Cl. CPC H05B 6/1209
USPC 99/332

(57) ABSTRACT

In a cooker according to the present invention, in order to prevent a heating capacity from being raised rapidly against the intention of a user, when a contactant which contacts an operating area of a display operating portion flicks the display operating portion, if a detected operation of the contactant such as flicking is in the direction to raise a heating capacity, a changing amount (a varying amount) of a heating capacity according to a moving speed of the contactant in the operating area is limited in comparison with the case that a detected operation of the contactant such as flicking is in the direction to lower a heating capacity.

### TECHNICAL FIELD

The present invention relates to a cooker having a touch panel, in particular relates to a movement of a displayed image of the cooker.

### BACKGROUND ART

A conventional cooker is provided with a plurality of keys having specific functions. Various setting operations for setting a heating power and a temperature are performed by operations such as depressing a key, holding down a key or the like. Recently, the number of a cooker having a touch panel is increased, and there is a proposed configuration that an image of a cooking recipe is changed at once or one after another by a depressing operation or a sliding operation on the touch panel (for example, refer to Patent Literature 1.).

### CITATION LIST

### Patent Literatures

Patent Literature 1: Unexamined Japanese Patent Publication No. 2012-37219

### SUMMARY OF INVENTION

### Technical Problem

In the touch panel of the cooker, there is a case that a setting of a heating capacity and a controlled temperature is continuously changed by performing a sliding operation to move a finger keeping in contact with the touch panel, or a flicking operation to flick a finger in a direction of a surface of the touch panel from a position where a finger is in contact with the touch panel. A speed to be changed and a displayed numeric value to be changed can be varied according to a moving speed of a finger. Therefore, according to a function in which if the moving speed of a finger becomes higher, the speed to be changed becomes higher or the displayed numeric value to be changed varies more, a movement of the displayed image becomes intuitive to a user. As a result, a cooker with an easy operation, a shortened operational time and a less operational work volume can be provided.

In the above-mentioned flicking operation, by setting such that a changing amount becomes large even if an operational time or an operation work volume is small, which brings a comfortable operational feeling to a user, a setting value can be changed quickly by an operation with a short operational time. In the cooker, however, if such flicking operation is performed at raising a heating capacity, there is a case such that the heating capacity is raised at once. For example, in the case of an IH cooking heater on which a pot or a pan is mounted and in which a setting of a heating capacity is performed during cooking, there is a possibility that a user contacts the touch panel by mistake during the cooking procedure. According to the manner to contact the touch panel, there is a possibility that by a misdetection such that the flicking operation has been performed, the heating capacity is raised close to a maximum value of the heating capacity rapidly against the intention of the user. Accordingly, the conventional cooker has a problem to cause a rapid boiling or a rapid rise of a temperature, in some cases, and thereby imparting uneasiness to a user.

### Solution to Problem

A cooker according to the present invention, for solving the above-mentioned problem, comprises a heating portion which heats an object to be heated, a display operating portion which sets a heating capacity corresponding to a heating power of said heating portion and a controlled temperature, and displays a setting information, and a control portion which controls said heating portion and said display operating portion, wherein said control portion is configured to determine a changing amount of the heating capacity of said heating portion in a condition after a contactant leaves an operating area of said display operating portion according to a leaving time moving direction and a leaving time moving speed just before the contactant leaves the operating area of said display operating portion after the contactant moves keeping in contact with the operating area of said display operating portion, and said control portion is configured such that in the case that said leaving time moving speed in a moving direction in which the heating capacity is lowered and said leaving time moving speed in a moving direction in which the heating capacity is raised are the same, the changing amount in the moving direction in which the heating capacity is raised is limited to being lower than the changing amount in the moving direction in which the heating capacity is lowered within at least a set extent. In the cooker according to the present invention as configured in the above-mentioned manner, even if the display operating portion detects an operation in the direction in which the heating capacity is raised, it can prevent a heating power from being raised at once against the intention of a user.

### Advantageous Effects of Invention

According to the cooker of the present invention, even if a user contacts a display operating portion of the cooker unexpectedly, which causes an operation to be the same as the operation in the direction in which a heating capacity is raised in the display operating portion, there is no risk such that the heating capacity is raised at once against the intention of the user. Therefore, it becomes a device with high reliability which does not impart uneasiness to the user, and in which a sense of security and a safety when using the cooker is enhanced.

### BRIEF DESCRIPTION OF DRAWINGS

FIG. 1 is a view illustrating a general configuration of a cooker according to the first embodiment of the present invention.

FIG. 2 is a schematic view illustrating an outline configuration of the cooker according to the first embodiment of the present invention.

FIGS. 3(a) through 3(h) are views illustrating a variety of examples of a display operating portion in the cooker according to the first embodiment of the present invention.

FIG. 4 is a flow chart at setting a heating power in the cooker according to the first embodiment of the present invention.

FIGS. 5(a) through 5(c) are views illustrating examples of a movement of a displayed image at setting the heating power in the cooker according to the first embodiment of the present invention.

FIG. 6 is a flow chart to determine a changing amount at setting the heating power in the cooker according to the first embodiment of the present invention.

### DESCRIPTION OF EMBODIMENTS

A cooker according to a first aspect of the present invention comprises: a heating portion which heats an object to be heated, a display operating portion which sets a heating capacity corresponding to a heating power of said heating portion and a controlled temperature, and displays a setting information, and a control portion which controls said heating portion and said display operating portion, wherein said control portion is configured to determine a changing amount of the heating capacity of said heating portion in a condition after a contactant leaves an operating area of said display operating portion according to a leaving time moving direction and a leaving time moving speed just before the contactant leaves the operating area of said display operating portion after the contactant moves keeping in contact with the operating area of said display operating portion, and said control portion is configured such that in the case that said leaving time moving speed in a moving direction in which the heating capacity is lowered and said leaving time moving speed in a moving direction in which the heating capacity is raised are the same, the changing amount in the moving direction in which the heating capacity is raised is limited to being lower than the changing amount in the moving direction in which the heating capacity is lowered.

In the cooker according to the first aspect of the present invention, when a heating capacity is raised by a flicking operation such that a finger as a contactant or another contactant flicks the operating area of the display operating portion, there is a limitation such that the heating capacity is not raised at once. Accordingly, even if a user contacts the display operating portion and performs an operation to be similar to the flicking operation by mistake, the cooker according to the first aspect of the present invention can prevent the situation that a heating capacity is raised at once against the intention of a user from being induced. Therefore, a cooker, which does not impart uneasiness to the user and in which a feeling of security and a safety are enhanced, can be provided.

Further, in the cooker according to the first aspect of the present invention, when a heating capacity is lowered by a flicking operation such that a finger or another contactant flicks the operating area of the display operating portion, since the operation to lower the heating capacity at once is not limited, it can comply with a demand of a user to lower the heating capacity at once when water is boiled over or scorching occurs. Accordingly, in the cooker according to the first aspect of the present invention, the heating capacity can be lowered to a large extent quickly by a single operation of the flicking operation. Therefore, the cooker does not impart uneasiness to a user, and a feeling of security and a safety are enhanced.

In the cooker according to a second aspect of the present invention, particularly said control portion according to said first aspect of the present invention can be configured to apply an upper limit to the changing amount in the moving direction in which the heating capacity is raised, and have a region to limit such that the changing amount in the moving direction in which the heating capacity is raised is smaller than the changing amount in the moving direction in which the heating capacity is lowered.

The cooker according to the second aspect of the present invention as configured in the above-mentioned manner can be applied as a specific method to limit such that the heating capacity is not raised at once when the heating capacity is raised by a flicking operation such that a finger as a contactant or another contactant flicks the operating area of the display operating portion. Consequently, the cooker according to the second aspect of the present invention can surely limit the maximum raised amount of the heating capacity by a single flicking operation.

In the cooker according to a third aspect of the present invention, particularly said control portion in said first or second aspect of the present invention is configured to control such that when a raised ratio of said leaving time moving speed relative to a constant changing amount in the direction in which the heating capacity is raised is larger than a lowered ratio of said leaving time moving speed relative to a constant changing amount in the direction in which the heating capacity is lowered by an approximately constant ratio, the changing amount to be determined in the moving direction in which the heating capacity is raised becomes equal to the changing amount to be determined in the moving direction in which the heating power is lowered.

According to the cooker according to the third aspect of the present invention as configured in the above-mentioned manner, it is possible to change a degree of easiness for changing according to the moving speed when a heating capacity is raised and according to the moving speed when a heating capacity is lowered. The cooker according to the third aspect of the present invention can provide easiness to lower a heating capacity, and give an impression of difficulty to raise a heating capacity to a user. Consequently, in the cooker according to the third aspect of the present invention, in the case that a user has a clear intention to raise a heating capacity, a changing amount (a varying amount) can be made large by increasing a moving speed of the contactant. Accordingly, an amount to raise a heating capacity can be made large according to a user's intention without imparting uneasiness to the user.

In the cooker according to a fourth aspect of the present invention, particularly said control portion in any one of said first to third aspects of the present invention is configured to determine whether the heating capacity is changed or not according to a contacting position and a moving direction of said contactant while said contactant moves keeping in contact with the operating area of said display operating portion, and determine the changing amount of the heating capacity according to a moving distance of said contactant, and said control portion is configured to determine such that the changing amount of the heating capacity just after said contactant leaves said operating area is 0 in the case that the heating capacity just before said contactant contacts said operating area is not the same as the heating capacity just before said contactant leaves said operating area, and the heating capacity has been changed from the heating capacity just before said contactant contacts said operating area to the heating capacity just before said contactant leaves said operating area.

In the cooker according to the fourth aspect of the present invention as configured in the above-mentioned manner, when a sliding operation such that a finger or another contactant moves keeping in contact with the operating area of the display operating portion is performed, a changing amount of the heating capacity is determined according to the moving distance in the direction in which a heating capacity is raised or in the direction in which a heating capacity is lowered, and a heating capacity can be raised or lowered by a plurality of steps continuously by the sliding operation without doing the flicking operation. Further, in the case that the flicking operation is performed successfully from the sliding operation to change the heating capacity, a changing process of the heating capacity just after the contactant leaves the operating area of the display operating portion is not performed, and only a setting change by the sliding operation is performed, and thereby providing a feeling of a stable operation. Consequently, in the cooker according to the fourth aspect of the present invention, a user can select any one of the sliding operation with a feeling of a stable operation and the flicking operation with a feeling of a quick and easy operation by an action of the user at the operation.

In the cooker according to a fifth aspect of the present invention, particularly in any one of said first to fourth aspects of the present invention, it can be configured such that said display operating portion has a heating capacity setting effective area where a heating capacity can be set by contact of said contactant, and wherein at a condition that a position where said contactant starts to contact said display operating portion and a position where said contactant leaves said display operating portion are located within said heating capacity setting effective area, a changing operation of the heating capacity is made effective, and in the case of a changing operation which does not fulfill said condition, a setting of the heating capacity is returned to a status just before said contactant starts to contact.

In the cooker according to the fifth aspect of the present invention as configured in the above-mentioned manner, it can limit a range to set a heating capacity, and therefore even if a user wipe the display operating portion with a piece of cloth, or a pot or a pan is slipped on a top surface of the display operating portion, it can reduce a possibility to change a heating capacity due to the misdetection such that the flicking operation or the sliding operation has been performed. Consequently, the cooker according to the fifth aspect of the present invention can provide a user with a feeling of security and can become a device in which a safety is further be enhanced.

In the cooker according to a sixth aspect of the present invention, particularly in any one of said first to fifth aspects of the present invention, said display operating portion further has a one-step down region where the heating capacity is lowered by one step when said contactant contacts the one-step down region, and a one-step up region where a heating capacity is raised by one step said contactant contacts the one-step up region.

The cooker according to the sixth aspect of the present invention as configured in the above-mentioned manner is configured such that a user can select any one of the following methods; the method to change a heating capacity by the sliding operation such that a finger or another contactant moves keeping in contact with the operating area of the display operating portion, the method to change a heating capacity by the flicking operation such as flicking the operating area, and the method to change a heating capacity by contacting the specific region of the display operating portion. Consequently, for a user who is used to changing a setting value step by step by the ordinary key operation, and is not good at the operation to slide or flick the operating area of the display operating portion, alternatives of the operating method can be increased, and the user can select a method to be suitable to the user, and thereby achieving to provide the operating methods in which every user can operate easily.

Hereinafter, embodiments of a cooker according to the present invention will be described, with reference to the accompanying drawings. The configurations of cookers will not be limited to the configurations according to the following embodiment(s) and also includes cookers based on technical concepts similar to the following embodiment(s).

### First Embodiment

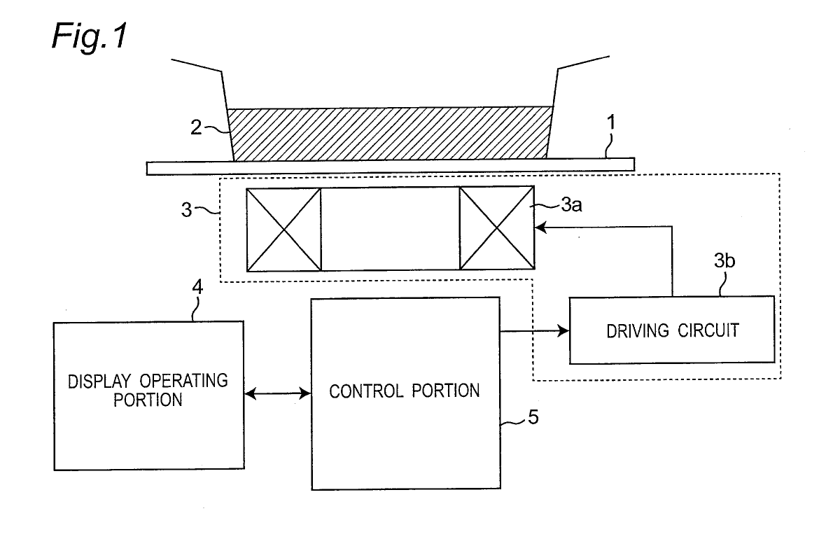

FIG. 1 is a view illustrating a general configuration of a cooker according to the first embodiment of the present invention.

In FIG. 1, a top plate 1 is placed on a top surface of a main body which forms an outer shell which is not illustrated. A heating portion 3 which heats an object to be heated such as a pot or a pan mounted on the top plate 1 is placed on an undersurface of the top plate 1 in the main body. The heating portion 3 is configured to include an induction heating coil 3a and a driving circuit 3b, and has a system for inductively heating the object to be heated.

In the cooker according to the first embodiment, a touch panel 4 which is a display operating portion is placed on a top surface of the top plate 1 or a side surface of a housing of the main body. According to an operation of a user, an operational signal relating to a selected menu, a heating start, a heating stop or the like is formed and transmitted to a control portion 5. The control portion 5 receives the operational signal from the touch panel 4, and controls the heating portion 3 according to the received operational signal.

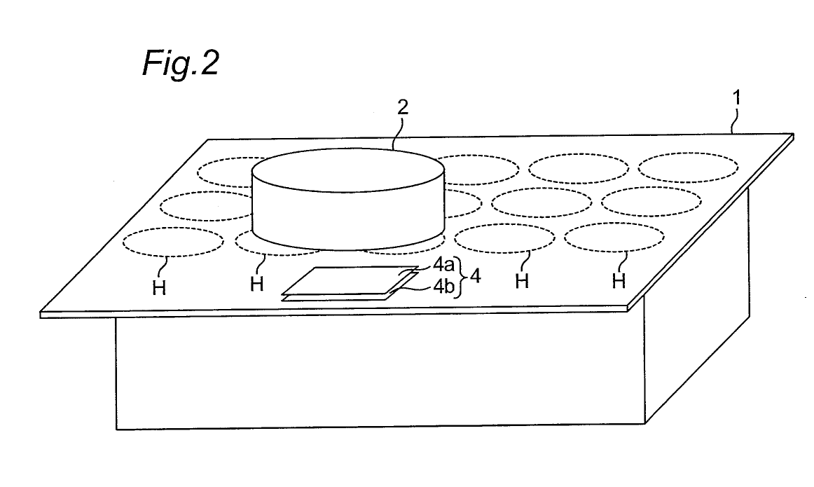

FIG. 2 is a view schematically illustrating the cooker according to the first embodiment of the present invention. As illustrated in FIG. 2, in the cooker according to the first embodiment, the top plate 1 has a plurality of heating areas H (areas indicated by a circle shape in dotted lines), and the induction heating coil 3a is placed as facing each other under each heating area H. The cooker according to the first embodiment is configured such that a position or a size of the object to be heated mounted on the top plate 1 is detected at certain intervals, and the heating portion 3 according to the detected position or detected size is driven. The touch panel 4 as the display operating portion is placed in a front side (a user's side) of the top surface of the top plate 1. The touch panel 4 is configured such that a display device 4b such as a liquid crystal panel and a position inputting device 4a of a resistive film type, or an electrostatic capacity type are combined as placing one on another.

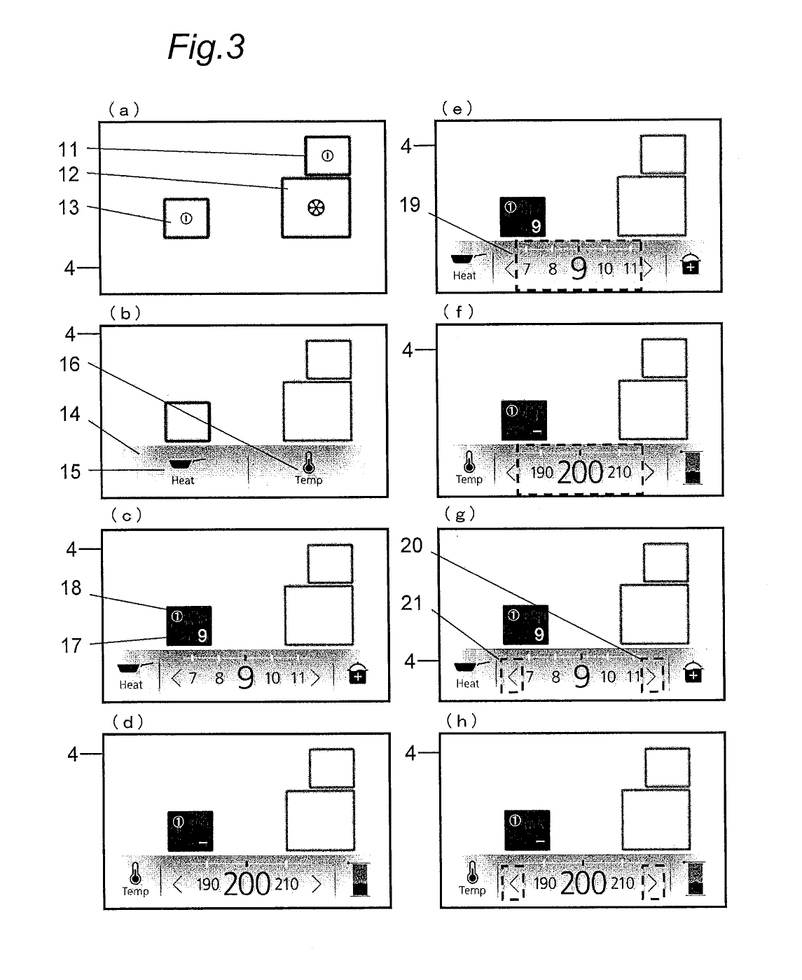

Views of FIGS. 3(a) to (h) are those illustrating a variety of examples of the touch panel (the display operating portion) of the cooker according to the first embodiment of the present invention.

The touch panel 4 as illustrated in FIG. 3(a) shows an example where three information 11, 12 and 13 of the objects to be heated which indicate a size and a position of the object 2 to be heated mounted on the top plate 1. The size and the position of the information 11, 12 and 13 of the objects to be heated, which are displayed on the touch panel 4, indicate the size of the object 2 to be heated and the corresponding position of the object 2 to be heated mounted on the top plate 1. The information 11, 12 and 13 of the objects to be heated is based on the detected information of the objects to be heated, which is detected by each of the heating portion 3.

As illustrated in FIG. 3(b), when a user selects the information of the object to be heated corresponding to the object 2 to be heated, which the user would like to heat such as the information 13 of the object to be heated in the information 11, 12 and 13 of the objects to be heated, which are displayed on the touch panel 4, and depresses a displayed frame of the information 13 of the object to be heated to be selected, a menu 14 is displayed on the lower part of the displaying surface of the touch panel 4. The menu 14 displayed on the touch panel 4 includes a heating cooking switch 15 which starts a heating cooking menu, and a temperature cooking switch 16 which starts a temperature cooking menu.

The heating cooking switch 15 is configured to start the heating cooking menu for setting a heating power so as to heat the object according to the set heating power. The temperature cooking switch 16 is configured to start the temperature cooking menu for setting a temperature so as to heat the object with the adjusted temperature. Accordingly, a user can selects either of the heating cooking switch 15 or the temperature cooking switch 16 in the menu 14 displayed on the lower part of the displaying surface of the touch panel 4.

For example, when a user selects the heating cooking switch 15 and depresses the heating cooking switch 15, the heating cooking menu starts and a heating power value which should be set is displayed on the lower part of the displaying surface as illustrated in FIG. 3(c). At this moment, only the displayed frame of the information 13 of the object 2 to be heated, which is selected, changes from a square white frame to a filled square shape. In addition, a setting value 17 of the heating power value and the heating stop button 18 are displayed in the square displayed frame of the object 2 to be heated, which is selected. As mentioned above, relating to a display of the information 11, 12 or 13 of the object to be heated; only a square white frame which is not filled is displayed when an object to be heated is detected to be mounted on the top plate 1. Then, when a user selects from the information of the object to be heated which is displayed, and heating process for the object to be heated which is selected starts, the displayed frame is shown with a filled square shape.

The cooker according to the first embodiment is configured such that in the heating power setting, it can be changed stepwise to a plurality of heating power values such as from 1 to 18, and the heating coils 3a are driven according to the electric power value corresponding to the respective heating power value. It is configured such that the heating cooking menus include various cooking menus such as a cooking menu to prevent boiling over, a cooking menu to circulate water by convection in the object to be heated such as a pot or a pan, and a user can select from such cooking menus.

On the contrary, in the displayed status as illustrated in FIG. 3(b), when a user selects the temperature cooking switch 16 and depresses the temperature cooking switch 16, the temperature cooking menu starts and an image for setting a temperature is displayed on the lower part of the displaying surface as illustrated in FIG. 3(d). In the cooker according to the first embodiment, in setting of the temperature of the temperature cooking menu, it can be set in every 10 degrees Celsius from 80 to 240 degrees Celsius. When the temperature is set, the heating coils 3a are driven by controlling the electric power value so as to keep the set temperature.

Next, a method for setting a heating power and a temperature in the cooker according to the first embodiment is described.

When a user sets a heating power, the user can select two methods. One method is to change a heating power setting by making a contactant such as a finger in contact with an heating capacity setting effective area (an operating area) 19 located on the lower part of the displaying surface of the touch panel 4, and then making the contactant move keeping in contact with a surface of the heating capacity setting effective area 19. In FIGS. 3(e) and (f), the area surrounded by the dotted lines is the heating capacity setting effective area 19.

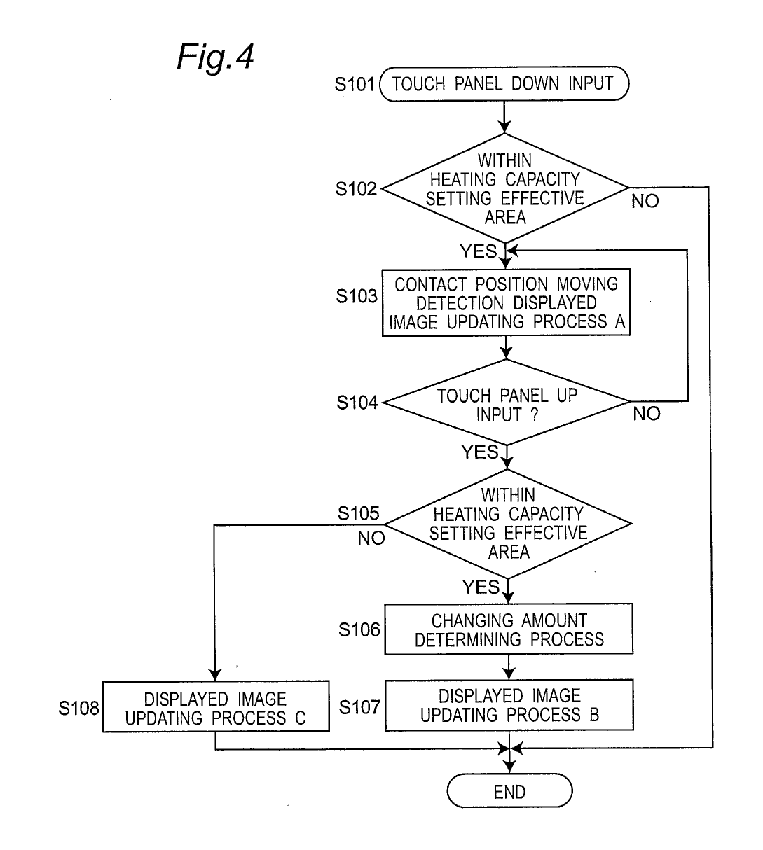

FIG. 4 is a flow chart for setting a heating power according to the first embodiment of the present invention, and it illustrates a flow when the heating capacity setting is changed according to the operation to make the contactant move keeping in contact with the heating capacity setting effective area 19. In the following description, a finger is exemplified as the contactant to be in contact with the touch panel 4.

When the contactant contacts the touch panel 4, a touch panel down input signal, which means that the contactant starts to contact the touch panel 4, is generated in Step S101. In Step S102, if it is judged that the contacting position on the touch panel 4 when the contactant contacts the touch panel 4 in Step S101 is located within the heating capacity setting effective area 19, an operation for setting a heating power can be performed, and then moving from Step S102 to Step S103.

On the contrary, if it is judged in Step S102 that the contacting position on the touch panel 4 when the contactant contacts the touch panel 4 in Step S101 is located without the heating capacity setting effective area 19, during the period that the contactant is kept in contact with the touch panel 4, even if the contactant moves and enters the heating capacity setting effective area 19, the operation for setting the heating power cannot be performed, and then the flow for setting the heating power is finished.

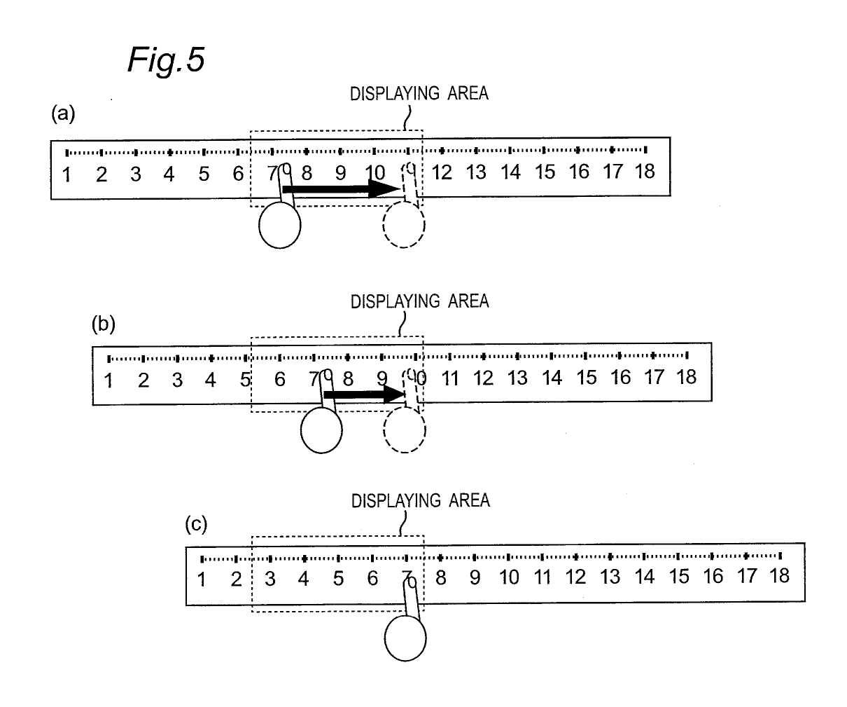

FIGS. 5(a) through 5(c) are views illustrating examples of a movement of a displayed image at setting a heating power according to the first embodiment of the present invention.

At setting a heating power according to the first embodiment, as illustrated in FIGS. 5(a) through 5(c), it is configured such that a part of a heating power value scale with a belt shape in which numbers from 1 to 18 are lined at equal intervals is displayed as the operating area in the heating capacity setting effective area 19 located on the lower part of the displaying surface of the touch panel 4. In the operating area of the heating capacity setting effective area 19, a constant range is displayed with positioning the setting value of the heating power in the center of the operating area. In Step S103, when a user makes the contactant in contact with the displaying area (19) of the heating power value scale and moves the contactant from the first contacting position, the heating power value scale with a belt shape moves similarly together with movement of the contactant. Consequently, a displayed image updating process A in which a displayed part of the heating power value scale in the displaying area is updated, is performed. For example, as illustrated in FIG. 5(a), when a user makes the contactant in contact with a position where “7” is displayed, and starts to move the contactant to the direction as shown by the arrow (direction to right side in FIGS. 5(a) through (c)), as illustrated in FIGS. 5(b) to (c), the displayed position of “7” moves sequentially to the right side corresponding to the movement of the contactant. Accordingly, while the contactant moves, the image in the displaying area is also kept updated.

Next, at the moment when the contactant leaves the touch panel 4 in Step S104, a touch panel up input signal is generated in the display operating portion which is the touch panel 4. If the position at the moment when the contactant leaves the touch panel 4 is not located within the heating capacity setting effective area 19, moving to Step S108, a displayed image updating process C is performed to return to the image of the displaying area (the heating power setting value) just before the contactant contacts the touch panel 4. The more the moving distance is changed at this moment, the faster the heating power value scale having the belt-shape slides. The displayed image updating process C, which returns to the previous image of the displaying area sequentially at a speed corresponding to the moving distance for changing, is performed such that the heating power value scale slides as mentioned above.

On the contrary, if the position at the moment when the contactant leaves the touch panel 4 is located within the heating capacity setting effective area 19, moving to Step S106, a changing amount determining process to determine a changing amount (a varying amount) according to the moving speed (the leaving time moving speed) of the contactant just before the contactant leaves the touch panel 4.

When the changing amount (the varying amount) is determined by the changing amount determining process, an image in the displaying area is updated consequently by a displayed image updating process B of Step S107.

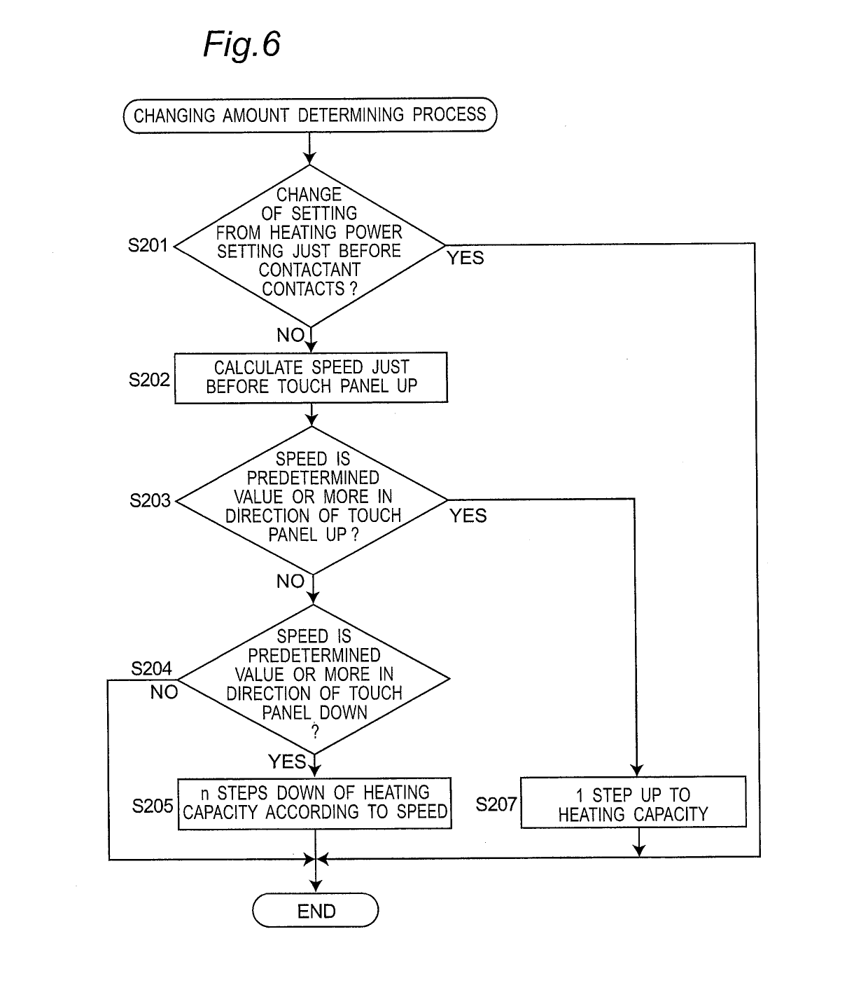

FIG. 6 illustrates a flow chart for determining a changing amount at setting a heating power in the cooker according to the first embodiment of the present invention. The flow chart for determining a changing amount at setting a heating power illustrates a detailed flow of the above-mentioned changing amount determining process in the step S106 as illustrated in FIG. 4.

First of all, when the changing amount determining process starts, in step S201, if a heating power setting value (a heating power displayed at the center of the displaying area) just before a contactant contacts the displaying area is not equal to a heating power setting value just before a contactant leaves the displaying area and a heating power setting value is changed from the heating power setting value just before a contactant contacts the displaying area to the heating power setting value just before a contactant leaves the displaying area, the changing amount determining process is completed. Thus, if the heating power value displayed in the center of the displaying area has been changed according to the movement of a contactant (a finger) for a predetermined distance or more from the first contacting position, the changing amount determining process is completed because the heating power value displayed at the center of the displaying area just before a contactant leaves the displaying area has already been determined as a heating power setting value.

On the contrary, if a heating power setting value just before a contactant contacts the displaying area is equal to the heating power setting value just before a contactant leaves the displaying area, thus, if the contactant (the finger) is moved only for a distance less than the predetermined distance from the first contacting position (which includes the case that the contactant is moved somewhere once, then moved back to the first contacting position), a moving speed (a leaving time moving speed) in the moving direction (a leaving time moving direction) just before the contactant (the finger) leaves the touch panel 4 is calculated in Step S202. If the calculated moving speed is a predetermined value or more in the direction in which a heating power is raised (the left direction in (e) of FIG. 3) (a flick operation), a heating power to be set is raised by one step in Step S207. At this moment, even if the leaving time moving speed is very high in the direction in which the heating power is raised, it is configured such that the heating power to be set is raised only by one step as an upper limit. As a heating power setting value, the heating power to be set is not raised beyond the maximum setting value (“18” is set as the maximum heating power value in the first embodiment).

If the calculated moving speed is a predetermined value or more in the direction in which a heating power is lowered (the right direction in (e) of FIG. 3), a heating power to be set is lowered by a changing amount to be approximately in proportion to the moving speed in Step S205. In this case, if the leaving time moving speed is higher, a changing amount (a varying amount) becomes larger. As a heating power setting value, however, the heating power to be set is not lowered beyond the minimum setting value (“1” is set as the minimum heating power value in the first embodiment).

As mentioned above, in Step S201 when the changing amount determining process starts, if there is performed a sliding operation in which a setting value is changed from the setting value just before a contactant contacts the displaying area to the setting value just before a contactant leaves the displaying area by moving a contactant (a finger) for the predetermined distance or more from the first contacting position, the changing amount determining process is completed only with performing this sliding operation. Thus, in Step S201, if a moving distance of a contactant (for example, a finger) in the sliding operation is the predetermined distance or more in the operating area as the heating capacity setting effective area 19, the setting value just before the contactant leaves the operating area is determined as a heating power setting value.

As mentioned above, in the cooker according to the first embodiment, while a contactant moves keeping in contact with the operating area of the touch panel 4, it is determined if a heating capacity will be changed or not according to a contacting position and a moving direction, and a changing amount of a heating capacity is determined according to a moving distance of the contactant. Then, if a heating capacity just before the contactant contacts the displaying area of the touch panel 4 is not equal to a heating capacity just before the contactant leaves the operating area, and a different value is set as a heating capacity, that is, a heating capacity has been changed from the heating capacity just before the contactant contacts the displaying area of the touch panel 4 to the heating capacity just before the contactant leaves the displaying area (the setting process of a heating power value is performed by the sliding operation), the control portion 5 is configured to determine such that a changing amount of a heating capacity becomes 0 even if the flicking operation is performed just after the contactant leaves the displaying area.

In Step S207, while it is explained with the example where a heating power is raised only by one step as an upper limit of a heating power setting value, any plurality of steps can be set as an upper limit value, and it can be set such that a heating power can be raised only by steps composed of the set plurality of the upper limit values. In this case, if a moving speed (a leaving time moving speed) just before a contactant leaves the touch panel 4 is less than a moving speed in which the an upper limit of the changing amount is set, a heating power setting value can be determined corresponding to a changing amount according to the moving speed and a heating power can be raised. On the contrary, if a moving speed (a leaving time moving speed) just before a contactant leaves the touch panel 4 is the moving speed in which the upper limit of the changing amount is set or more, a changing amount is limited to the value set as the maximum value (the upper limit value). According to such setting, in the direction in which the heating power is raised, a changing amount after a contactant such as a finger leaves by a flicking operation of a user can be admitted to the extent not to impart uneasiness to a user. As the result, the cooker according to the first embodiment can have a safe and reliable configuration such that it does not impart uneasiness to a user even if the user operates to raise a heating power to a large extent by mistake as well as a quick operation can be performed by the flicking operation.

As mentioned above, in the changing amount determining process of Step S106, the upper limit value is applied to the changing amount in the direction in which a heating capacity is raised, and the control portion 5 provides an area where a changing amount in the direction in which the heating capacity is raised is lower than a changing amount in the direction in which the heating capacity is lowered, such as the area where a changing amount is changed only by one step or two steps.

As the changing amount determining process of Step S106, in case that a changing amount is determined after a contactant leaves for the direction in which a heating power is raised, in addition to the method to set the maximum value as mentioned above, the following method is described as another embodiment.

When a raised ratio relative to a constant changing amount (a varying amount) at a moving speed just before a contactant leaves an operating area (a leaving time moving speed) in the direction in which a heating power is raised is larger than a lowered ratio relative to a constant changing amount (a varying amount) at a moving speed just before a contactant leaves an operating area (a leaving time moving speed) in the direction in which a heating power is lowered by an approximately constant ratio, a changing amount to be determined in the moving direction in which a heating power is raised can be equal to a changing amount to be determined in the moving direction in which a heating power is lowered. Thus, when a heating power setting value so far is set as a center value and a new setting value is set by adding or deducting a same changing amount (a varying amount) of a heating power relative to the center value, a moving speed just before a contactant leaves the operating area (a leaving time moving speed) in the moving direction in which a heating power is raised needs to be faster than a moving seed just before a contactant leaves the operating area (a leaving time moving speed) in the moving direction in which a heating power is lowered by approximately constant times. In other words, in a leaving time moving speed in the moving direction in which a heating power is raised and a leaving time moving speed in the moving direction in which a heating power is lowered, even if the moving speed just before a contactant leaves in respective direction is the same, a changing amount of a heating capacity to be determined in the moving direction in which a heating power is raised is lower than a changing amount of a heating capacity to be determined in the moving direction in which a heating power is lowered by the approximately constant times.

Hereinafter, the above-mentioned method of changing amount determining process is described using specific figures. For example, in the case that a changing amount (a varying amount) is set “−5” when a moving speed of a contactant in the direction in which a heating power is lowered is “5”, “10” is set as a moving speed required for making a changing amount (a varying amount) in the direction in which a heating power is raised “+5” which is the same number as an absolute figure. In the case to set in this manner, a moving speed in the moving direction in which a heating power is raised needs to be twice faster than a moving speed in the moving direction in which a heating power is lowered.

As mentioned above, in the method of the changing amount determining process, if a raised ratio of a leaving time moving speed in the direction in which a heating power is raised is larger than a lowered ratio of a leaving time moving speed in the direction in which a heating power is lowered by the approximately constant ratio, the control portion 5 controls such that a changing amount to be determined in the moving direction in which a heating power is raised becomes equal to a changing amount to be determined in the moving direction in which a heating power is lowered.

By using the above-mentioned method for the changing amount determining process, it works such that a changing amount is not likely to be changed according to an operation feeling in the direction in which a heating power is raised in comparison with an operation feeling in the direction in which a heating power is lowered. Accordingly, it is configured such that even if a user feels that an operation to raise a heating power to a large extent has been performed by mistake, an actual changing amount to raise a heating power becomes smaller by the constant ratio, and thereby avoids imparting uneasiness to the user. Further, in the case that a user intentionally lowers a heating power to a large extent, it can be achieved by increasing a moving speed of a contactant, and it can be addressed by a configuration not prohibiting a quick operation using a flick operation.

In the first embodiment, in the setting method to make a moving speed just before a contactant leaves (a leaving time moving speed) in the moving direction in which a heating power is raised larger than a moving speed just before a contactant leaves (a leaving time moving speed) in the moving direction in which a heating power is lowered by an approximately constant times in order to equalize changing amounts (varying amounts) in the moving direction in which a heating power is raised and in the moving direction in which a heating power is lowered, a setting process can be applied from a point that a moving speed is 0, or the setting process can be applied from a predetermined value in which an absolute figure of a moving speed is more than 0. For example, in a moving speed in which a changing amount is within one step, even in a case of the moving direction in which a heating power is raised, if a moving speed is the same as a moving speed in the moving direction in which a heating power is lowered, the same changing amount (the same varying amount) is determined. In a moving speed in which a changing amount (a varying amount) exceeds one step, a different changing amount can be set by an approximately constant ratio for a portion of the moving speed adding to the moving speed corresponding to one step of the changing amount. By setting in this manner, in either of the directions in which a heating power is raised and in which a heating temperature is lowered, a user can operate with a similar feeling up to the state that a changing amount becomes one step. In a moving speed in which a changing amount exceeds one step, it can be set such that an operation to raise a heating power is not likely to be change in comparison with an operation to lower a heating power. At this moment, as a changing amount to change an operation feeling, it is not limited to one step. Even in the case of two steps or more, the same effect can be obtained.

As mentioned above, the method to change an operational feeling from the feeling of the specific changing amount is described below using specific figures.

For example, according to a moving speed corresponding to a change in the range of the specific value that a changing amount (a varying amount) of a setting value changes from −1 (one step in the direction in which a heating power is lowered) to +1 (one step in the direction in which a heating power is raised), no difference is made between the direction a heating power is raised and the direction in which a heating power is lowered.

On the contrary, according to a moving speed corresponding to a change in which an absolute figure of a setting value of a changing amount (a varying amount) exceeds 1, difference is made between the direction a heating power is raised and the direction in which a heating power is lowered. An example is described below using specific figures in such a case that difference in the moving speed is made between the direction a heating power is raised and the direction in which a heating power is lowered.

For example, in the moving direction to lower a heating power, a changing amount when a moving speed is “−2” is set “−1”, a changing amount when a moving speed is “−4” (a portion exceeding the moving speed “−2” is “−2”) is set “−2”, and a changing amount when a moving speed is “−6” (a portion exceeding the moving speed “−2” is “−4”) is set “−3”. Accordingly, in the direction to lower a heating power, a moving speed and a changing amount (a varying amount) have a simply proportional relationship, if the moving speed becomes twice, the changing amount becomes also twice.

In the direction to raise a heating power, a changing amount when a moving speed is “+2” is set “+1”, a changing amount when a moving speed is “+6” (a portion exceeding the moving speed “+2” is “+4”) is set “+2”, and a changing amount when a moving speed is “+10” (a portion exceeding the moving speed “+2” is “+8”) is set “+3”. In this case, relating to a relationship between a moving speed and a changing amount (a varying amount) in the direction to raise a heating power, in comparison with the case that a moving speed is “+2”, a changing amount becomes twice when a moving speed becomes three times, and a changing amount becomes three times when a moving speed becomes five times. As described in the above-mentioned example, when a raised ratio of a leaving time moving speed relative to a constant changing amount in the direction in which a heating power is raised is higher than a lowered ratio of a leaving time moving speed relative to a constant changing amount in the direction in which a heating power is lowered by an approximately constant ratio, it is set such that a changing amount to be determined in the moving direction in which a heating power is raised and a changing amount to be determined in the moving direction in which a heating power is lowered are equalized.

In the above-mentioned specific example, a specific amount to change an operational feeling is within a range between −1 to +1. In the case of the setting that exceeds this range of the specific figure, a moving speed in the direction to raise a heating power needs to be higher than the direction to lower a heating power.

In the cooker according to the first embodiment, as another method that a user changes a heating power setting, there is a method to perform a heating power setting by depressing a heating power raising area 20 or a heating power lowering area 21 as illustrated in the dotted line in FIGS. 3(g) and 3(h). In this method, when a finger as a contactant or another contactant contacts the heating power raising area 20 or the heating power lowering area 21, each heating power setting value is raised or lowered by one step. Further, when water is boiled over an object to be heated such as a pot or a pan, or scorching occurs in an object to be heated, a user demands to lower the heating power at once. In order to correspond to this demand of the user, without making a finger or another contactant contact the heating power lowering area 21 again and again, it can be set such that a heating power setting value is lowered by a plurality of steps at once when it takes a certain period of the time under the condition that a finger or another contactant keeps in contact with the heating power lowering area 21, or a function to lower a heating power to a minimum setting value at once is provided. In the case that a contactant contacts the heating power raising area 20, even if it takes a certain period of the time under the condition in contact with the heating power raising area 20, a heating power cannot be raised to the next step of the heating power setting value unless the contactant leaves the touch panel 4 once and then contacts the touch panel 4 again after a heating power setting value is raised by one step primarily. Accordingly, when the contactant contacts the heating power raising area 20, a heating power is not raised even if it takes a certain period of the time under the condition in contact with the heating power raising area 20.

In the cooker according to the first embodiment of the present invention, even if a user contacts the position inputting device 4a of the touch panel 4 unexpectedly, there is no risk to cause the situation that a heating capacity is raised at once against the intention of the user. On the contrary, when a user would like to lower a heating capacity urgently, it is configured such that a heating power can be lowered by a plurality of steps at once according to the user's operation. Accordingly, the cooker according to the first embodiment of the present invention does not impart uneasiness to a user and can provide a user with a feeling of security, and further becomes a convenient cooking device in which an operability and a safety are enhanced.

Since a user can select an operational method according to the user's preference from the methods such as sliding operation to trace along a surface of the touch panel, a flicking operation to flick a surface of the touch panel, and an operation to depress a button on the touch panel, a handleability for the user is enhanced even if the user has no experience to use the touch panel.

While the above-mentioned embodiment is described with using examples of a movement of a displayed image at setting a heating power, it can also be applied to the movement of a displayed image at setting a temperature, and it will have a similar effect (refer to Figs. (f) and (h)). In this case, for example, it can be set such that one step of a heating power value corresponds to 10 degrees Celsius for a setting temperature.

The cooking heater according to the present invention is provided to solve the above-mentioned problems of the conventional arts. When an operation (a flicking operation) that the contactant flicks the surface of the touch panel as a display operating portion is detected, a changing amount of the heating capacity is determined according to a moving speed of the contactant. In this case, the cooking heater according to the present invention is configured such that if the detected flicking operation is the operation to raise the heating capacity, the changing amount (the varying amount) is limited in comparison with the operation to lower the heating capacity. According to such configuration, in the cooker according to the present invention, even if there is detected the operation to flick in the direction to raise the heating capacity against the intention of a user, there is no risk to cause the situation that the heating capacity is raised at once unexpectedly to the user.

While the present invention has been described according to the embodiments with a certain degrees of details, contents of disclosure of the embodiments shall be varied in details of the configuration, and the combination of elements and the change of order in the embodiment can be realized without deviating from the scope of the claims and concepts of the present invention.

### INDUSTRIAL APPLICABILITY

Since the cooker according to the present invention can avoid a risk that a user contacts an operating portion such as a touch panel unexpectedly, and thereby raising the heating capacity against the intention of a user. Therefore, it can be applicable to devices which utilize a variety of touch panels which change an output in real time by operating the touch panel or the like.

### REFERENCE SIGNS LIST

1 Top plate
2 Object to be heated
3 Heating portion
3a Induction heating coil
3b Driving circuit
4 Touch panel (Display operating portion)
4a Position inputting device
4b Display device
5 Control portion

1. A cooker comprising:
a heating portion which heats an object to be heated,
a display operating portion which sets a heating capacity corresponding to a heating power of said heating portion and a controlled temperature, and displays a setting information, and
a control portion which controls said heating portion and said display operating portion,
wherein said control portion is configured to determine a changing amount of the heating capacity of said heating portion in a condition after a contactant leaves an operating area of said display operating portion according to a leaving time moving direction and a leaving time moving speed just before the contactant leaves the operating area of said display operating portion after the contactant moves keeping in contact with the operating area of said display operating portion, and
said control portion is configured such that in the case that said leaving time moving speed in a moving direction in which the heating capacity is lowered and said leaving time moving speed in a moving direction in which the heating capacity is raised are the same, the changing amount in the moving direction in which the heating capacity is raised is limited to being lower than the changing amount in the moving direction in which the heating capacity is lowered.

2. The cooker according to claim 1, wherein
said control portion applies an upper limit to the changing amount in the moving direction in which the heating capacity is raised, and has a region to limit such that the changing amount in the moving direction in which the heating capacity is raised is smaller than the changing amount in the moving direction in which the heating capacity is lowered.

3. The cooker according to claim 1, wherein
said control portion is configured to control such that when a raised ratio of said leaving time moving speed relative to a constant changing amount in the direction in which the heating capacity is raised is larger than a lowered ratio of said leaving time moving speed relative to a constant changing amount in the direction in which the heating capacity is lowered by an approximately constant ratio, the changing amount to be determined in the moving direction in which the heating capacity is raised becomes equal to the changing amount to be determined in the moving direction in which the heating power is lowered.

4. The cooker according to claim 1, wherein
said control portion is configured to determine whether the heating capacity is changed or not according to a contacting position and a moving direction of said contactant while said contactant moves keeping in contact with the operating area of said display operating portion, and determine the changing amount of the heating capacity according to a moving distance of said contactant, and
said control portion is configured to determine such that the changing amount of the heating capacity just after said contactant leaves said operating area is 0 in the case that the heating capacity just before said contactant contacts said operating area is not the same as the heating capacity just before said contactant leaves said operating area, and the heating capacity has been changed from the heating capacity just before said contactant contacts said operating area to the heating capacity just before said contactant leaves said operating area.

5. The cooker according to claim 1, wherein
said display operating portion has a heating capacity setting effective area where a heating capacity can be set by contact of said contactant, and
wherein at a condition that a position where said contactant starts to contact said display operating portion and a position where said contactant leaves said display operating portion are located within said heating capacity setting effective area, a changing operation of the heating capacity is made effective, and
in the case of a changing operation which does not fulfill said condition, a setting of the heating capacity is returned to a status just before said contactant starts to contact.

6. The cooker according to claim 1, wherein
said display operating portion further has a one-step down region where the heating capacity is lowered by one step when said contactant contacts the one-step down region, and a one-step up region where a heating capacity is raised by one step when said contactant contacts the one-step up region.

7. The cooker according to claim 2, wherein
said control portion is configured to control such that when a raised ratio of said leaving time moving speed relative to a constant changing amount in the direction in which the heating capacity is raised is larger than a lowered ratio of said leaving time moving speed relative to a constant changing amount in the direction in which the heating capacity is lowered by an approximately constant ratio, the changing amount to be determined in the moving direction in which the heating capacity is raised becomes equal to the changing amount to be determined in the moving direction in which the heating power is lowered.

8. The cooker according to claim 2, wherein
said control portion is configured to determine whether the heating capacity is changed or not according to a contacting position and a moving direction of said contactant while said cotactant moves keeping in contact with the operating area of said display operating portion, and determine the changing amount of the heating capacity according to a moving distance of said contactant, and
said control portion is configured to determine such that the changing amount of the heating capacity just after said contactant leaves said operating area is 0 in the case that the heating capacity just before said contactant contacts said operating area is not the same as the heating capacity just before said contactant leaves said operating area, and the heating capacity has been changed from the heating capacity just before said contactant contacts said operating area to the heating capacity just before said contactant leaves said operating area.

9. The cooker according to claim 3, wherein
said control portion is configured to determine whether the heating capacity is changed or not according to a contacting position and a moving direction of said contactant while said cotactant moves keeping in contact with the operating area of said display operating portion, and determine the changing amount of the heating capacity according to a moving distance of said contactant, and
said control portion is configured to determine such that the changing amount of the heating capacity just after said contactant leaves said operating area is 0 in the case that the heating capacity just before said contactant contacts said operating area is not the same as the heating capacity just before said contactant leaves said operating area, and the heating capacity has been changed from the heating capacity just before said contactant contacts said operating area to the heating capacity just before said contactant leaves said operating area.

10. The cooker according to claim 2, wherein
said display operating portion has a heating capacity setting effective area where a heating capacity can be set by contact of said contactant, and
wherein at a condition that a position where said contactant starts to contact said display operating portion and a position where said contactant leaves said display operating portion are located within said heating capacity setting effective area, a changing operation of the heating capacity is made effective, and
in the case of a changing operation which does not fulfill said condition, a setting of the heating capacity is returned to a status just before said contactant starts to contact.

11. The cooker according to claim 3, wherein
said display operating portion has a heating capacity setting effective area where a heating capacity can be set by contact of said contactant, and
wherein at a condition that a position where said contactant starts to contact said display operating portion and a position where said contactant leaves said display operating portion are located within said heating capacity setting effective area, a changing operation of the heating capacity is made effective, and
in the case of a changing operation which does not fulfill said condition, a setting of the heating capacity is returned to a status just before said contactant starts to contact.

12. The cooker according to claim 4, wherein
said display operating portion has a heating capacity setting effective area where a heating capacity can be set by contact of said contactant, and
wherein at a condition that a position where said contactant starts to contact said display operating portion and a position where said contactant leaves said display operating portion are located within said heating capacity setting effective area, a changing operation of the heating capacity is made effective, and
in the case of a changing operation which does not fulfill said condition, a setting of the heating capacity is returned to a status just before said contactant starts to contact.

13. The cooker according to claim 2, wherein
said display operating portion further has a one-step down region where the heating capacity is lowered by one step when said contactant contacts the one-step down region, and a one-step up region where a heating capacity is raised by one step when said contactant contacts the one-step up region.

14. The cooker according to claim 3, wherein
said display operating portion further has a one-step down region where the heating capacity is lowered by one step when said contactant contacts the one-step down region, and a one-step up region where a heating capacity is raised by one step when said contactant contacts the one-step up region.

15. The cooker according to claim 4, wherein
said display operating portion further has a one-step down region where the heating capacity is lowered by one step when said contactant contacts the one-step down region, and a one-step up region where a heating capacity is raised by one step when said contactant contacts the one-step up region.

16. The cooker according to claim 5, wherein
said display operating portion further has a one-step down region where the heating capacity is lowered by one step when said contactant contacts the one-step down region, and a one-step up region where a heating capacity is raised by one step when said contactant contacts the one-step up region.
